(19) United States
(12) Patent Application Publication
(10) Pub. No.: US 2010/0174518 A1
(43) Pub. Date: Jul. 8, 2010

(54) METHOD FOR PREDICTING AN IMPACT OF AN AGING BEHAVIOUR OF AN ELECTRICAL ELEMENT AND SIMULATION MODEL FOR SIMULATING SUCH BEHAVIOUR

(75) Inventors: Eilert Johansson, Molnlycke (SE); Lars Mattsson, Molndal (SE)

Correspondence Address: WRB-IP LLP, 801 N. Pitt Street, Suite 123, ALEXANDRIA, VA, 22314, US

(73) Assignee: VOLVO TECHNOLOGY CORP., Göteborg (SE)

(21) Appl. No.: 12/294,630

(22) PCT Filed: Apr. 19, 2007
(86) PCT No.: PCT/SE2007/000375

§ 371 Date: Sep. 26, 2008

(30) Foreign Application Priority Data
Apr. 19, 2006 (SE) PCT/SE2006/000462

(51) Int. Cl. G09B 23/18; G06F 17/50

(52) U.S. Cl. 703/13

(57) ABSTRACT

A method is provided for predicting an impact of an aging behavior of a connector element, which simulates degradation states caused by aging of the connector element by means of at least one resistor element and a voltage source, as well as a computer program performing the method, a computer readable medium including the computer program, and a simulation model for simulating a degraded connector element.

### BACKGROUND AND SUMMARY

The present invention relates to method for predicting an impact of an aging behaviour of an electrical element, particularly a connector element, a computer program for calculating an impact of the aging behaviour using the method, a computer readable medium comprising the computer program, and a simulation model for simulating an aging behaviour of the electrical element.

In general, an electrical connector element consists of or comprises two metal surfaces which are pressed together to enable an electrical current to float between them. Even absolutely clean metal surfaces of connector elements are not ideally flat, but show, microscopic observed, elevations and depressions. When these two metal surfaces are pressed together, an electrical contact can not be obtained over the whole surface, but contact can only be established where elevations of the surface irregularities reach each other (contact spots).

If the metal surfaces are not absolutely clean—which is normally the case, because of surface films of contaminants, oxides etc.,—electrons will only be able to pass where a contact force is able to wipe off or crack the surface film. This results in a certain contact resistance.

With time several aging mechanism change the contact situation. E.g. the contact force can decrease due to mechanical relaxation and is therefore not sufficient any more to crack or wipe off the surface film. On the other hand the amount of oxides/contaminants or the thickness of the surface film can increase due to general corrosion and the accumulation of contaminants, respectively.

Another problem is that the contact surfaces are in relative motion because of thermal expansions or vibrations which lead to fretting. Fretting in turn causes a degradation of the contact surfaces due to wear, fatigue damage, plastic deformation or fretting corrosion.

As a result of the mechanisms described above, the electrically conducting contact area is further reduced, which will lead to an increase in contact resistance. Eventually, the degraded contact becomes unstable, with high or fluctuating contact resistance.

The instability in turn has an impact on the system, sub-system or electrical circuit comprising the degraded connector element which can result not only in malfunction as for example wrong indications but in the worst case in a complete failure of the system, subsystem or circuit.

It is desirable to provide a method for predicting an impact of a degraded connector element on a system, sub-system or electrical circuit.

In a working contact, the result of the above-described instability is detectable as an intermittent or open contact, an increase in temperature, an increase of electromagnetic radiation, etc.

Therefore, the inventive method uses as main elements at least one resistor element and a voltage source for simulating the different contact resistance behaviours of a degraded connector element. The advantage of including the voltage source into the simulation model itself is that it could be used to model galvanic voltages or other voltages picked up by a contact due to a degraded state. Such voltages can be caused by corrosion or other degradation states and can have a significant impact on a transmitted signal.

Based on the simulated different contact resistances the method can calculate the impact of the degraded connector element on a system, subsystem or circuit. This implies a possibility to design circuits for robustness with respect to an aging of connector elements.

The calculation of the impact of the degraded connector element on a system, sub-system or circuit is necessary, since the detection of an increased resistance alone can be erratic, because the movement itself can lead to a rapid increase of contact resistance when the contact spot is moved to an insulating area, followed by good conduction when the contact spot moves further to a conducting area.

Moreover, the electrical properties do not need to be influenced immediately by the degradation mechanism, due to the fact that the contacts are often designed with several connector elements in parallel and that each connector element comprises several contact spots, make up a redundant system.

The main advantage of an aspect of the invention is that an aspect of the inventive method is able to predict an impact of a degraded connector element on a system or sub-system which in turn enables e.g. a user to distinguish between the impact of an open connector due to e.g. movement and the impact of an open connector due to degradation on the system.

The inventive method can therefore, according to an aspect thereof, be used to predict influences of contact degradations on a system level. Incorporation of the inventive method several times within a circuit simulation, each time for example with its own parameter setting, provides a possibility to see complex and interaction effects of contact degradation on the functionality of large systems. Such effects are impossible to predict by other methods known from the state of the art.

Preferably, the method is performed by means of at least one variably adjustable resistor which simulates the degradation states of an electrical connector element. That means the resistance can be increased for a chosen period of time of adjustable length. This simulates the different degradations states. For example a slightly increased resistance can correspond to an increase in thickness of the surface films or an increase in the amount of contaminants/oxides. In this case the connector element is still closed but the connecting resistance is increased which can also result in an increase in temperature. Nevertheless, this increase in temperature can be different to the increase in temperature caused by an open connector element and therefore the impact on the system is different.

In other preferred embodiments of the present invention, the method is further performed by means of an inductor element for simulating an inductance and/or a capacitor element for simulating a capacitance between two contact surfaces and/or a switch for selecting one of two resistor elements and/or a pulse source for controlling a switch. By means of these elements the simulation of the degradation states can be fine-adjusted.

It is further preferred that the method is performed by a computer and, as shown in another embodiment, the behaviour of elements such as resistor or inductor is virtually simulated by a corresponding computer program and can be translated to analogue signals by, for example, a digital/analogue device.

### BRIEF DESCRIPTION OF THE DRAWINGS

The invention may be understood more clearly by reference to the following detailed description of the drawings. However, description and drawings are only illustrative of preferred embodiments and are not intended that the present invention is limited thereto.

The figures show:

FIG. 1: a schematic simulation model for implementing a first preferred embodiment of the method for simulating a degraded electrical connector element according to the present invention, and

FIG. 2: a schematic simulation model for implementing a second preferred embodiment of the method for simulating a degraded electrical connector element according to the present invention.

### DETAILED DESCRIPTION

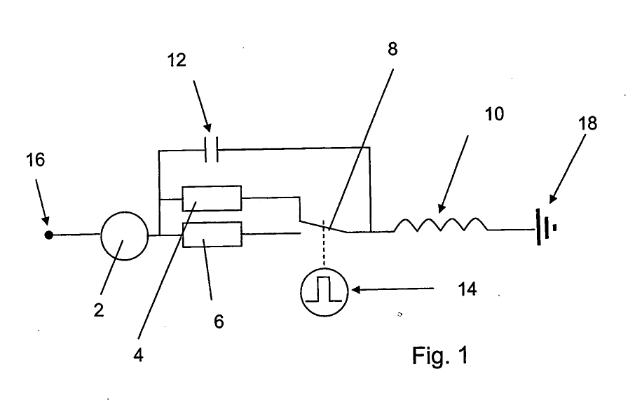

FIG. 1 shows schematically a preferred embodiment of a simulation model for implementing the method of the present invention for predicting the impact of a degraded electrical connector on a system, sub-system or circuit.

The model can contain six major parts, where all six, or just a limited set of them can be used. As shown in FIG. 1 the model contains a voltage source 2 to simulate the behaviour of a galvanic voltage, two serial resistors 4, 6 to simulate the behaviour of a connector element, particularly the contact resistance and the serial resistance during a micro break, respectively. The model further comprises a switch 8 to simulate the behaviour of a micro break, an inductor 10 to simulate an inductance, a capacitor 12 to simulate a capacitance, and a pulse source 14 for controlling the switch.

Micro breaks are short interruptions in the connection of a connector element that are particularly caused by movement which can lead to a rapid increase of the contact resistance when the contact spot is moved to an insulating area, followed by a good conduction when the contact spot is further moved to a conducting area. This short interruption or open state of the connector element may last for only a tenth of a microsecond but can have a great impact on a system as for example a digital communication can be disturbed.

The voltage source 2 simulates a constant voltage source. The simulated voltage source can be a parameterised voltage corresponding to a galvanic voltage which appears in the physical contact element. Galvanic voltage in general appears between two metals and it size can be influenced by an increased/decreased amount of contaminants or oxides on the surface of the contact elements.

The resistors 4, 6 simulate typical resistances in a connector element. The resistance is parameterised, to be able to be adjusted to the physical contact element. In case the resistance increases due to e.g. an increased thickness of surface films or a deterioration of the flatness of the contact surface due to wear, a single resistor 4 can be used, which resistance is adaptable to the increased/decreased connector resistance.

In case the resistors are intended to simulate micro breaks, at least two resistors having a different resistance are preferred. As shown in FIG. 1, there is further a switch 8 for selecting resistor 4 or 6. By switching between the two resistors 4 and 6 and therefore between two resistance sizes a good connection and an almost open state of the connector can be simulated. The good connection is simulated by a very low resistance. It is also possible to simulate micro breaks by a single resistor switching between a no-resistance state without a resistor (very good connection) and a resistance state. However, this simulation model can not take into account a deterioration of the connection due to aging of the connector elements since the simulated no-resistance of the closed connection is not adjustable.

The switch 8 can be controlled by a pulse source 14, which could be random, periodic or have any other kind of relevant timing behaviour. The pulse source 14 can be an autonomous element or can be included into a computer performing a program for controlling the simulation.

It is also possible to combine the resistors and the switch into a transistor.

The inductor 10 simulates a serial inductance in a connector element and the capacitor 12 simulates a capacitance between the two contact surfaces of the connector.

It is also possible to extend the simulation model to a thermal behaviour of resistor/s 4 and/or 6, taking into account the material behaviour of a simulation model element with increased temperature.

Furthermore, the model of FIG. 1 comprises a connection point 16 for connecting the model to a system e.g. a vehicle or a circuit on which the impact of the degraded connector element should be simulated. Connection point 18 in FIG. 1 provides a connection to ground.

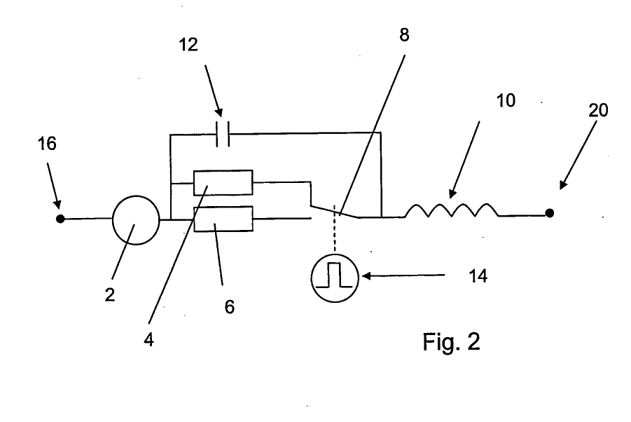

FIG. 2 shows a schematic simulation model for implementing a second preferred embodiment of the method for simulating a degraded electrical connector element according to the present invention. The simulation model shows a connection point 20 to a further circuit. The further circuit can be for example a communication system or a sensor system. In a very preferred embodiment the connection point 20 provides a connection to a sensor mounted directly onto an engine. Otherwise, the simulation model in FIG. 2 is identical with the simulation model of FIG. 1. Therefore, the other reference figures in FIG. 2 have the same meaning as the reference figures in FIG. 1.

Depending on the physical connector element which is simulated, and its environment, one or several parts of the simulation model can be omitted. On the other hand it can be preferred to connect a plurality of the simulation model elements in series or parallel in order to simulate the effect of lost redundancy in a multi-element connector. This can be realized by using a statistical approach.

The controlling of the simulation model and/or the calculation of the impact of the simulated degraded connector element can be performed by a computer program. It can be also preferred to use a computer program which simulates one or more element (s) of the simulation model virtually.

1. A method for predicting an impact of an aging behavior of an electrical element, particularly a connector element wherein the method simulates degradation states caused by aging of the connector element by means of at least one resistor element and a voltage source.

2. The method according to claim 1, wherein the method calculates the impact of the degradation states of the connector element on a system, a subsystem and/or an electrical circuit on basis of the simulated degradation states.

3. The method according to claim 1, wherein the resistor element is variable and simulates a serial resistance in the connector element.

4. The method according to claim 1, wherein further the method simulates the degradation states of the connector element by an inductor element for simulating a serial inductance in the connector element.

5. The method according to claim 4, wherein the at least one resistor element and the switch are designed as one element.

6. The method according to claim 4, wherein further the method simulates the degradation states of the connector element by means of a pulse source for controlling the switch, wherein the pulse source has a random, periodic or other timing behavior.

7. The method according to claim 1, wherein the resistor element further simulates a thermal behavior of the connector element and/or the indicator element and/or the capacitor element.

8. The method according to claim 1, wherein the simulated degradation states of the connector element correspond to aging mechanisms of the connector element, particularly mechanical relaxation, surface films, oxides, contaminants, general corrosion, plastic deformation, fretting corrosion, fatigue damage, different thermal expansions, and/or vibrations.

9. The method according to claim 1, wherein the method is performed by a computer.

10. The method according to claim 9, wherein at least one element for performing the method is virtual model of the corresponding physical element.

11. A computer program to be executed on a computer for predicting an impact of a degraded connector element by using a method according to claim 1.

12. The computer program according to claim 11, wherein the computer program is stored on a computer readable medium.

13. A computer readable medium comprising a computer program for predicting an impact of a degraded connector element using the method according to claim 1.

14. Simulation model for simulating an aging behavior of an electrical element comprising at least one resistor element and a voltage source, wherein the electrical element is a connector element, and the at least one resistor element is adjusted to simulate degradation states caused by aging of the connector element.

15. The model according to claim 14, further comprising an inductor element for simulating an inductance in the connector element, and/or a capacitor element for simulating a capacitance between two connecting surfaces of the connector element, and/or a switch which selects a resistance element, and/or a pulse source for controlling the switch, wherein the pulse source has a random, periodic or other timing behavior.

16. The model according to claim 15, wherein the resistor and the switch are one element.

17. The method according to claim 1, wherein further the method simulates the degradation states of the connector element by a capacitor element for simulating a capacitance between two connecting surfaces of the connector element.

18. The method according to claim 1, wherein further the method simulates the degradation states of the connector element by a switch which selects a resistance element.
